(19) United States
(12) Patent Application Publication
(10) Pub. No.: US 2024/0394903 A1
(43) Pub. Date: Nov. 28, 2024

(54) Providing Surroundings Data of a Motor Vehicle

(71) Applicant: Bayerische Motoren Werke Aktiengesellschaft, Muenchen (DE)

(72) Inventor: Marco SPITZER, Weichs (DE)

(21) Appl. No.: 18/673,441

(22) Filed: May 24, 2024

(30) Foreign Application Priority Data
May 26, 2023 (DE) 10 2023 113 974.6

(51) Int. Cl. G06T 7/40; G06T 5/77; G06T 11/00; G06V 20/58

(52) U.S. Cl. CPC G06T 7/40; G06T 5/77; G06T 11/001; G06V 20/58; G06T 2207/20081; G06T 2207/30252

(57) ABSTRACT

A method of providing surroundings data of a motor vehicle includes scanning an environment of the motor vehicle, recognizing a scanned object in the environment, determining a texture of the scanned object, and creating a textured representation of the scanned object.

### CROSS REFERENCE TO RELATED APPLICATION

This application claims priority under 35 U.S.C. § 119 from German Patent Application No. 10 2023 113 974.6, filed May 26, 2023, the entire disclosure of which is herein expressly incorporated by reference.

### BACKGROUND AND SUMMARY

The present invention relates to providing surroundings data of a motor vehicle. In particular, the invention relates to providing map data.

A motor vehicle comprises a local map memory in which map information regarding an environment is stored. The map information may comprise in particular a road network on which the motor vehicle can travel. Between a current position and a predetermined destination position, a route may be determined on the basis of the road path information. A driver of the motor vehicle may be given indications which enable the driver to follow the route. Such indications may concern, for example, a maneuver such as turning off at an intersection or entering or exiting an interstate highway.

The maneuver may be represented graphically by a procedure in which a view of a road that is being traveled is represented and an indication of the maneuver, for example, a direction arrow, is superimposed on the representation. The more realistic the view of the environment, the easier it may be for the driver to implement the displayed maneuver and to steer the motor vehicle in the correct direction.

The map data may comprise information about landmarks situated in the region of the road network. The landmarks may be represented in greater or lesser detail so that the driver can recognize them in an improved manner. However, existing map data is often sketchy with regard to available landmarks, and symbolic or abstract environment information tends to be represented between the landmarks. By way of example, in a town/city center, a uniform block that may represent buildings may be represented between two landmarks. Particularly in the absence of a landmark represented with a good level of detail in the field of view, the driver may find it difficult to implement a proposed maneuver correctly on the basis of abstractly or symbolically represented surroundings.

The present invention is based on the object of providing improved surroundings data of a motor vehicle. The invention achieves this object by means of the subjects of the independent claims. Preferred embodiments are specified in dependent claims.

According to a first aspect of the present invention, a method comprises the steps of scanning an environment of a motor vehicle; recognizing a scanned object in the surroundings; determining a texture of the scanned object; and creating a textured representation of the object.

By means of the method, the recognized object can be represented realistically in an improved manner by virtue of the fact that it bears a texture which was observed previously. The texture may comprise surface information, in particular a color, a pattern, a structure or regular or irregular interruptions. If the object comprises a residential building, for example, then different textures may be represented for different sections of the residential building. The textures may be interrupted by windows or doors, for example, or a window or a door may be regarded as part of a texture or as an independent texture.

Recognizing preferably comprises determining which of the scanning data concern the object, and which do not. Furthermore, a geometric shape of the object may be determined. In this case, an approximation for the shape may be accepted; for example, a house may be represented by a parallelepiped. Other abstractions or composite shapes are likewise possible. The geometric shape is preferably three-dimensional, even if the scans only contain incomplete information about the shape.

The object may comprise a landmark, in particular a building. The building may comprise, for example, a residential building, a church, a public building, an office complex or a hall. Other exemplary landmarks comprise for instance an elevation, vegetation such as one or more trees, a roadway, for example, in the form of an entrance, an on-ramp or an off-ramp, a traffic sign or a stretch of water.

Preferably, a plurality of scans of the object are collected, wherein the textured representation of the object is determined on the basis of the scans. In a first variant, respective textures can be determined for different scans before the determined textures are brought together for the textured representation of the object. In another variant, the scans can firstly be combined before a texture of the object is determined. Combining preferably concerns determining which section of a scan is arranged at which point of the geometric shape of the object. When determining a texture, metainformation can be taken into account, for example, lighting prevailing at the time of scanning if an optical scan is involved, a current season or an age of the scan.

It is further preferred for the scans to originate from different motor vehicles. Preferably, a fleet of motor vehicles can be used to create scans from a predetermined geographical area, wherein textured representations of one or more objects in the area can be determined on the basis of the scans. The scans can be sorted, for example, with regard to a resolution, a perspective or a driving speed during scanning. Matching items of information can be reinforced and items of information that deviate from one another can be attenuated. In this regard, the reliability of the existing scanning data can be determined for different sections of the object. The reliability can be taken into account in the determination of the textured representation.

It is particularly preferred for the scans to show different sections of the object. In this case, the scans can overlap one another. The more often a section was captured by a scan, the more reliable information related to this section may be. On the other hand, an all the greater proportion of the surface of the object can be scanned, the more the scans vary among one another.

It is particularly preferred for the textured representation to be determined taking account of a distortion which follows from a perspective of the motor vehicle relative to the object. In this way, scans which are determined from different perspectives can be processed or correlated with one another in an improved manner.

In order to recognize the object, a geographical position of the motor vehicle can be determined. The object can be recognized on the basis of map data in the region of the determined position. The map data can comprise, for example, a geometric shape of the object. The geometric shape can be enriched by means of texture information in order to provide a textured representation. On the basis of the geographical position of the motor vehicle and a perspective from which a scan was produced, the object can easily be found in the map data. If the map data already bear texture information, then the texture information comprised by the scan can be brought together with the existing texture information.

It is possible for a section of the object not to be captured by any of the scans. In this case, a texture on this section can be determined on the basis of a texture on another section of the object. In one simple embodiment, texture information can be adopted from an adjoining section with respect to which scanning data are present. However, it is preferred that even more distant sections can be used for determining the texture on the non-scanned section.

The texture on the section can be determined by means of machine learning methods. Such methods can also comprise artificial intelligence. By way of example, a correspondingly trained artificial neural network (ANN) can be used for this purpose.

In one particularly preferred embodiment, the texture on the section is determined by means of inpainting. Inpainting techniques are usually used to restore damaged or deteriorated photographs. Such a technique can comprise in particular providing texture information on a predetermined section on the basis of image information of a surrounding region. This can involve applying a graphical form of interpolation in the area. Another technique that can be used for determining the texture of the object is outpainting. In this case, an artificial intelligence algorithm is used to extend an existing image by adding contents outside the original image region. In contrast to inpainting, where missing parts of an image are restored, outpainting aims to extend the image content by adding more surroundings or context. In a way inpainting and outpainting correspond to interpolation and extrapolation of measured values using artificial intelligence methods. In a further embodiment, the texture can be determined on the basis of stable diffusion.

In one development of the invention, map data comprising the textured object can be provided. The map data can comprise different planes representing different contents. One of the planes can be provided for the representation of landmarks. It is preferred for the representation of the textured object to relate to this plane.

It should be taken into consideration that scans can be processed alternatively on board the motor vehicle or at a central station. Optionally, it is also possible for one portion of the processing to be carried out by the motor vehicle, and another by the central station. The map information is preferably created by the central station. In this case, the map information can be checked and compared with other information. The map information can subsequently be provided to practically any desired number of motor vehicles, for example, in the form of a map update. Alternatively, map information can also be kept available by the central station in order to provide it when requested by a motor vehicle.

According to a further aspect of the present invention, a system comprises a scanning device on board a motor vehicle, wherein the scanning device is configured for scanning an environment of the motor vehicle, and also a central station configured to receive a scan, to recognize a scanned object in the surroundings, to determine a texture of the scanned object, and to determine a textured representation of the object.

The scanning device preferably operates optically and can comprise in particular an external camera of the motor vehicle. A plurality of scanning devices can also be attached to the motor vehicle, which scanning devices can differ in particular in terms of their perspectives. The scanning device can also operate differently, for example, on the basis of LiDAR, radar or ultrasound. In one embodiment, one or more scanning devices on board the motor vehicle are provided for collecting both geometric information and optical information about the object.

The central station is preferably situated outside the motor vehicle and can receive information from the motor vehicle by means of a wireless communication connection. The motor vehicle can also receive a representation of a textured object from the central station by the same means.

The system can comprise a plurality of motor vehicles, wherein the central station is preferably configured to collect scans from the motor vehicles and to determine the textured representation on the basis of the scans.

A motor vehicle preferably comprises an automobile or a motorcycle. In further embodiments, a motor vehicle can also comprise a truck or a bus, for example.

The system can be configured to partly or fully carry out a method described herein. For this purpose, on the part of the motor vehicle and/or on the part of the central station, a preferably electronic processing device can be provided, which can comprise in particular a programmable microcomputer or microcontroller. The method can be present in the form of a computer program product with program code means. The computer program product can also be stored on a computer-readable data carrier. Features or advantages of the method can be applied to the system, or vice versa.

According to yet another aspect of the present invention, it is proposed to use inpainting to determine a texture on one section of an object on the basis of text information on another section of the object. The texture information is preferably determined on the basis of one or more scans of the object from one or more motor vehicles. The scans can be combined with geometric information about the shape of the object in order to create an at least sectionally textured representation of the object. In a further variant, outpainting is used to determine the texture on the section with respect to which direct information is not available. By applying artificial intelligence methods, it is possible to determine a convincing texture which fits well in an overall image composed of direct information available.

It is generally preferred for the generation of textual information to be applied maximally to a predetermined proportion of the visible surface of the object. By way of example, generation of texture information on more than approximately 10% or approximately 20% of the visible surface of the object may be rejected. The restriction makes it possible to prevent grossly incorrect or inconsistent information from being disseminated. On the other hand, possible errors or deviations in relation to reality on an area below the defined threshold value may be accepted in order to ensure recognition of the object by an observer on site. The threshold value can be adapted even more accurately depending on experience in the creation of texture data.

The invention will now be described in more detail with reference to the attached drawings, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system;

FIG. 2 illustrates a flowchart of a method; and

FIG. 3 illustrates a scan of an exemplary object.

### DETAILED DESCRIPTION OF THE DRAWINGS

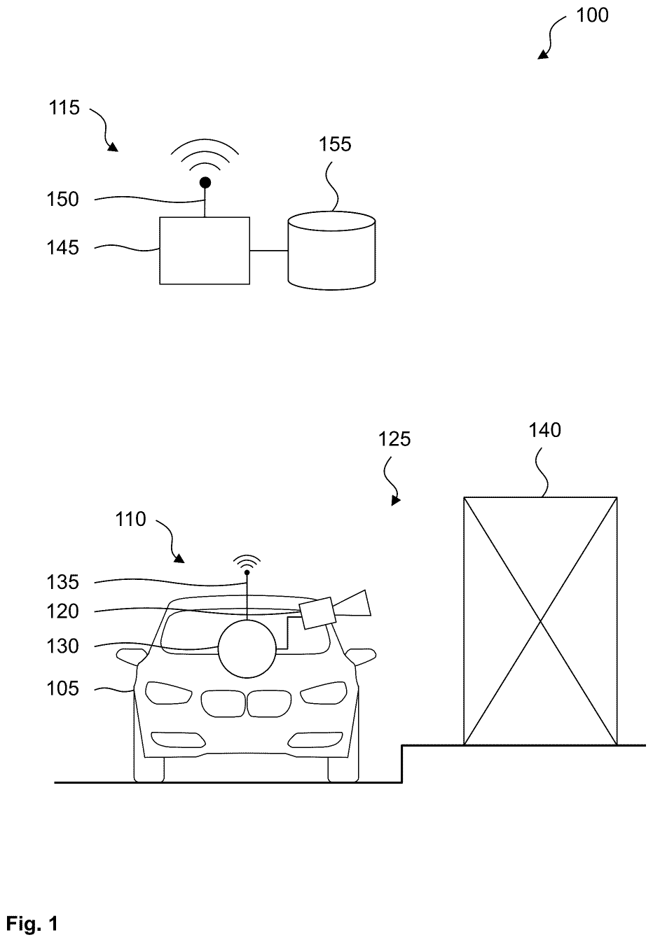

FIG. 1 shows a system 100 comprising a motor vehicle 105 with an apparatus 110 attached thereto, and also a central station 115. The motor vehicle 105 is illustrated by way of example as an automobile. The central station 115 is situated outside the motor vehicle 105.

The apparatus 110 comprises a scanning device 120 for scanning an environment 125 of the motor vehicle 105, and preferably a processing device 130. A wireless communication device 135 can be provided for communication with the central station 115.

The scanning device 120 preferably operates optically and can comprise for example a camera, a color camera, a stereo camera, a depth camera or a LiDAR sensor. A plurality of scanning devices 120 can also be used. A scan of the environment 125 provided by means of the scanning device 120 can comprise image data of an object 140 situated in the environment 125. In the illustration in FIG. 1, a schematically illustrated building is assumed by way of example as the object 140.

A viewing angle, a focal length, a resolution and an orientation of the scanning device 120 on the motor vehicle 105 can each be fixedly predetermined. However, some of these parameters can also be controllable, in particular by means of the processing device 130. The object 140 is usually three-dimensional and cannot be fully optically captured from an arbitrary perspective from the motor vehicle 105. However, portions of the object 140 whose surfaces face the motor vehicle 105 can be imaged on one or more scans. A scan can comprise the entire region of the object 140 that is optically capturable from the present perspective, or a section thereof. The scanning device 120 can be controlled to provide scans of the environment 125 periodically or in an event-controlled manner. The more slowly the motor vehicle 105 is traveling or the greater the distance between the object 140 and the motor vehicle 105, the less frequently the scanning device 120 can scan the environment 125.

In one embodiment, the processing device 130 is configured to forward a scan from the scanning device 120 to the central station 115 without any change. Optionally, a plurality of scans can be combined or compressed. In another embodiment, the processing device 130 can also process one or more scans before it communicates a result of the processing to the central station 115.

The central station 115 preferably comprises a processing device 145, a communication device 150 and preferably a data memory 155. One- or two-way exchange of information with the motor vehicle 105 or the apparatus 110 can be effected by means of the communication device 150. Preferably, the communication device 150 is configured to communicate with a plurality of motor vehicles 105. The processing device 145 is configured to receive scans from at least one motor vehicle 105 and to process them further. Received information or processing results can be stored in the data memory 155.

It is proposed to use scans of the object 140 from one or more motor vehicles 105 in order to determine a texture of the object 140 and to provide a textured representation of the object 140. The texture comprises in particular visible surface information, for example a color, a structure or a division. The collected information about one or more objects 140 can be used as a basis for providing map information. The map information can be distributed to one or more motor vehicles 105. On board a motor vehicle 105, a representation of an environment 125 generated on the basis of map information can utilize a textured representation of the object 140 in order to provide an improved realistic view of the environment 125. Such a view can be utilized for example for providing a driver of the motor vehicle 105 with an indication to follow a predetermined route.

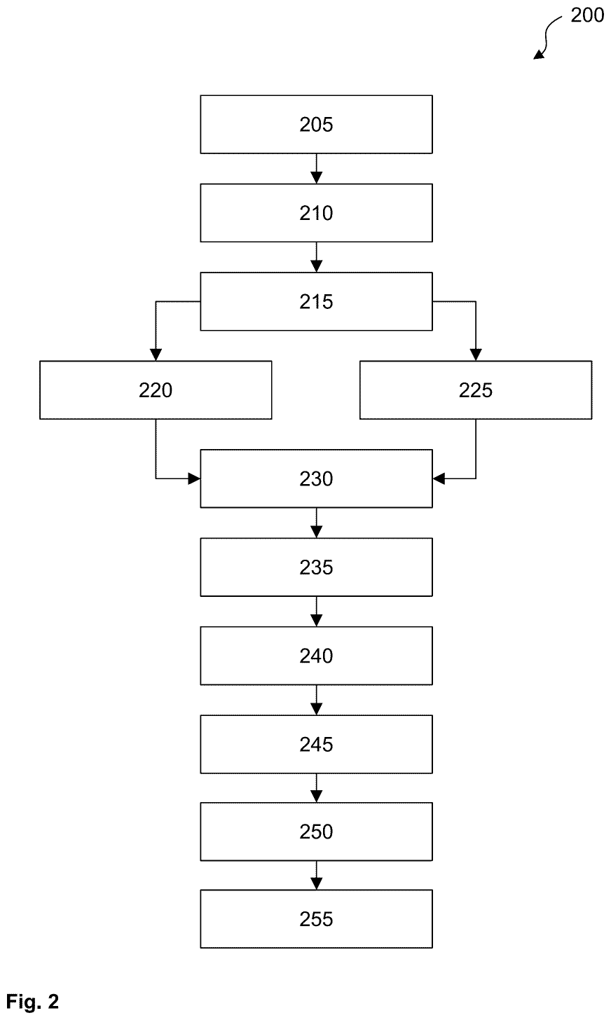

FIG. 2 shows a flowchart of a method 200 for providing surroundings data of a motor vehicle 105. The method 200 can be carried out in particular by means of a system 100. It should be taken into consideration that the method 200 is preferably carried out by a plurality of motor vehicles 105. For the sake of improved clarity, reference is made to only a single motor vehicle 105 for the purpose of describing the method.

In a step 205, the environment 125 of the motor vehicle 105 can be scanned. The scanning can be effected by means of one or more scanning devices 120. In a step 210, a geographical position of the motor vehicle 105 can be determined. The position can be determined for example by means of a receiver for a satellite-aided global navigation system (GNSS). Alternatively, the position can also be determined for example on the basis of map data and landmarks recognized in the environment 125.

In a step 215, an object 140 situated in the environment 125 can be recognized. Information from the scan can be used for this purpose. By way of example, it is possible to use automatic image recognition configured to recognize typical objects 140 which may situated in the region of a roadway for the motor vehicle 105. Such objects comprise for example buildings, public amenities or vegetation. The object 140 can also be determined on the basis of map data in the region of the determined geographical position. The map data can comprise a designation, a position and/or geometric information about the object 140. In a further preferred embodiment, both variants can be combined with one another.

In a step 220, it is possible to determine a texture of the object 140 on the scan produced previously. In parallel therewith, the pose of the scan in relation to the object 140 can be determined in a step 225. The pose can indicate which section of the object 140 is to be recognized on the scan and optionally how the section or the scan must be geometrically distorted in order to provide a view of the object 140 from a different perspective. This distortion rectification can be carried out before the texture is evaluated in step 220.

In a step 230, textures of different sections of the object 140 can be merged. For this purpose, mutually overlapping sections of the scans can be determined and fused together. If a sufficient number of scans is available, then a texture can be determined for a large portion of the surface of the object 140. Surfaces of the object 140 that face away from places on which a motor vehicle 105 can travel cannot usually be captured in this way. The determination of textures in these regions can be dispensed with, particularly if a textured representation of the object 140 that is provided later is intended to be used only on board motor vehicles 105.

In a step 235, a section of the object 140 with respect to which no items of texture information or no scans are available can be determined. This may typically be the case for a section of the object 140 located at a relatively high level.

In a step 240, a texture on the determined section can be determined on the basis of texture information at another region of the object 140. A machine learning method can be used for this purpose. It is preferred for the determination of the texture on the missing section to be determined by means of inpainting and/or outpainting methods. In the case of outpainting, an artificial intelligence algorithm can be used to extend an available image of the surface of the object 140 by adding contents outside the original image region. In this case, the image content can be extended by adding more surroundings or context.

In a step 245, a textured representation of the object 140 can be provided. The textured representation preferably comprises geometric information and texture information. A view of the object 140 from an arbitrary perspective can thus be generated.

In a step 250, the determined representation can be integrated into map data already present. In this case, the map data concern a region around the geographical position of the motor vehicle 105.

In a step 255, the determined map data or the textured representation of the object 140 can be provided to a motor vehicle 105. This can be a different motor vehicle 105 than the one from which a scan of the object 140 was carried out. Preferably, the map data are provided to a plurality of motor vehicles 105.

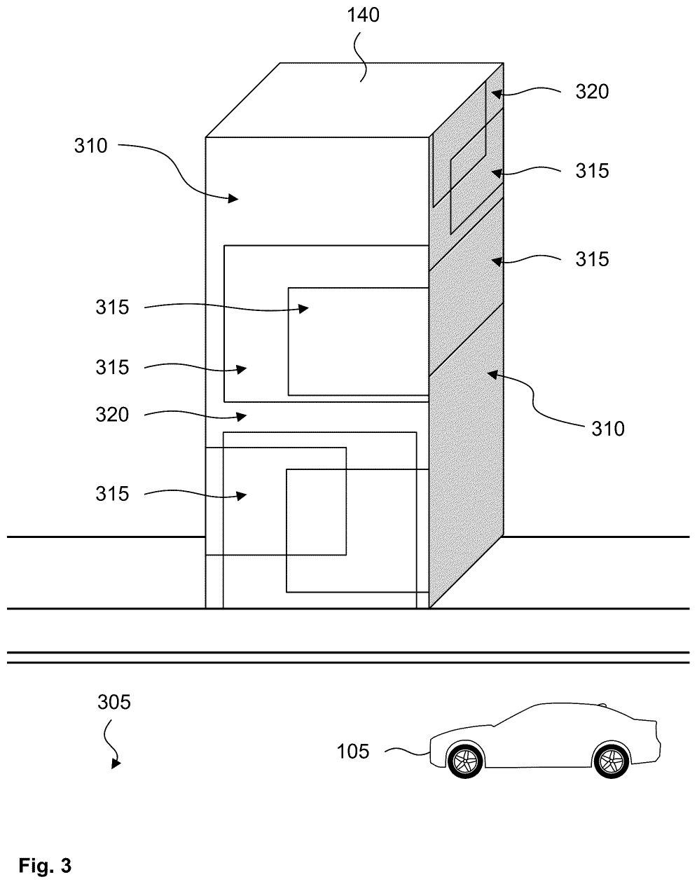

FIG. 3 shows a scan of an exemplary object 140 from a roadway 305 on which a motor vehicle 105 is traveling. The object 140 is once again assumed by way of example to be a building and is illustrated in isolation from other objects. Two side surfaces 310 of the object 140 are illustrated in FIG. 3. Exemplary sections 315 with respect to which scans are present are depicted on these side surfaces 310. Sections 315 located at different height levels can be scanned for example by motor vehicles 105 of different heights. Sections 315 situated far up on the building 140, as illustrated in a right-hand region, may also have been scanned from an obliquely positioned motor vehicle 105, for example while it uses an entrance or an exit, for instance in regard to a garage.

A portion of a side surface 310 that is not covered by at least one section 315 may be referred to as a missing section 320. No scanning information and accordingly also no direct texture information are available for missing sections 320.

Under a predetermined condition, for instance if an area of the object 140 with respect to which sections 315 with direct scans are present has reached a predetermined proportion of the total surface area of the object 140, then missing sections 320 can be created by means of artificial intelligence methods from the field of image processing and in particular image generation. Texture information for such sections 320 can preferably be determined on the basis of interpolation or extrapolation, in particular by means of inpainting or outpainting, on the basis of information of the scanned sections 315.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 System
105 Motor vehicle
110 Apparatus
115 Central station
120 Scanning device
125 Environment
130 Processing device
135 Communication device
140 Object
145 Processing device
150 Communication device
155 Data memory
200 Method
205 Scan environment
210 Determine position
215 Recognize object
220 Determine texture
225 Determine pose of the scan
230 Merge textures
235 Determine missing section
240 Determine texture on the section
245 Provide textured representation
250 Integrate representation into map data
255 Provide map data
305 Roadway
310 Side surface
315 Section
320 Missing section

What is claimed is:

1. A method comprising:
scanning an environment of a motor vehicle;
recognizing a scanned object in the environment;
determining a texture of the scanned object; and
creating a textured representation of the scanned object.

2. The method according to claim 1, wherein a plurality of scans of the scanned object are collected; and wherein the textured representation of the scanned object is determined based on the scans.

3. The method according to claim 2, wherein the scans originate from different motor vehicles.

4. The method according to claim 2, wherein the scans show different sections of the scanned object.

5. The method according to claim 3, wherein the scans show different sections of the scanned object.

6. The method according to claim 1, wherein the textured representation is determined taking account of a distortion of the scans which follows from a perspective of the motor vehicle relative to the scanned object.

7. The method according to claim 2, wherein the textured representation is determined taking account of a distortion of the scans which follows from a perspective of the motor vehicle relative to the scanned object.

8. The method according to claim 1, wherein a geographical position of the motor vehicle is determined; and wherein the scanned object is recognized based on map data in a region of the geographical position.

9. The method according to claim 2, wherein a geographical position of the motor vehicle is determined; and wherein the scanned object is recognized based on map data in a region of the geographical position.

10. The method according to claim 1, wherein a texture on one section of the scanned object, with respect to which no scan is present, is determined based on a texture on another section of the scanned object.

11. The method according to claim 2, wherein a texture on one section of the scanned object, with respect to which no scan is present, is determined based on a texture on another section of the scanned object.

12. The method according to claim 10, wherein the texture on the section is determined by machine learning.

13. The method according to claim 10, wherein the texture on the section is determined by inpainting.

14. The method according to claim 3, further comprising providing map data which comprise the scanned object.

15. The method according to claim 4, further comprising providing map data which comprise the scanned object.

16. The method according to claim 14, wherein the map data are communicated to a plurality of motor vehicles.

17. A system comprising:
a scanning device on board a motor vehicle, wherein the scanning device is configured for scanning an environment of the motor vehicle; and
a central station configured to receive a scan, to recognize a scanned object in the environment, to determine a texture of the scanned object, and to determine a textured representation of the scanned object.

18. The system according to claim 17, further comprising a plurality of motor vehicles, wherein the central station is configured to collect scans from the motor vehicles and to determine the textured representation based on the scans.

19. The system according to claim 17, wherein a texture on one section of the scanned object is determined by inpainting based on texture information on another section of the scanned object.
